(19) United States
(12) Patent Application Publication
(10) Pub. No.: US 2026/0100793 A1
(43) Pub. Date: Apr. 9, 2026

(54) UPLINK BEAM MANAGEMENT FOR ENABLING SIMULTANEOUS TRANSMISSION OR RECEPTION FROM MULTIPLE ANTENNA PANELS

(71) Applicant: Telefonaktiebolaget LM Ericsson (publ), Stockholm (SE)

(72) Inventors: Sven JACOBSSON, Västra Frölunda (SE); Fredrik ATHLEY, Västra Frölunda (SE); Andreas NILSSON, Göteborg (SE)

(73) Assignee: Telefonaktiebolaget LM Ericsson (publ), Stockholm (SE)

(21) Appl. No.: 19/114,681

(22) PCT Filed: Jan. 10, 2023
(86) PCT No.: PCT/SE2023/050023

§ 371 Date: Mar. 24, 2025

(30) Foreign Application Priority Data
Sep. 28, 2022 (WO) PCT/EP2022/076975

(51) Int. Cl. H04L 5/00; H04B 7/06

(52) U.S. Cl. CPC H04L 5/005; H04B 7/06952

(57) ABSTRACT

Uplink beam management for enabling simultaneous transmission or reception from multiple antenna panels A method in a wireless device (120) for facilitating an uplink reference signal, UL RS, based beam management procedure, the method comprising: indicating to a network (110) a capability of simultaneous transmission and/or reception from multiple panels (126), each panel representing a group of related antennas; receiving from the network an uplink reference signal, UL RS, configuration indicating at least two UL RS resources to be transmitted from different panels; and transmitting on one or more of the UL RS resources using the different panels in accordance with the UL RS configuration.

### TECHNICAL FIELD

The present disclosure relates to the field of cellular communication between multiantenna transceivers. In particular, it proposes a technique for determining a beam suitable for communication between a network node and a wireless device capable of simultaneous transmission or reception from multiple antenna panels.

### BACKGROUND

In the high frequency range, such as the FR2 range in 3GPP NR, multiple radio-frequency (RF) beams may be used to transmit and receive signals at a gNB and a user equipment (UE). For each downlink (DL) transmit (Tx) beam from a gNB, there is typically an associated best UE receive (Rx) beam for receiving signals from the DL beam. The DL Tx beam and the associated UE Rx beam form a beam pair; the DL beam and the associated UE Rx beam may be imagined connected by a conceptual beam pair link. The beam pair can be identified through a so-called beam management process in NR.

In deployments with multiple transmission points (TRP) or distributed multiple-input multiple-output (D-MIMO) millimeter-wave (mmWave) communication, it may be beneficial to use sounding reference signal (SRS) based beam management procedures—and uplink (UL) beam management procedures in particular—to determine suitable beam pair links between the network and the UE instead of using DL beam management procedures. Indeed, for multi-TRP or D-MIMO mmWave deployments, the beam management overhead for DL beam management procedure will be very high, since for each UE there are multiple different beams from multiple different TRPs or access points (APs) that need to be evaluated frequently.

A further level of difficulty is introduced if the UE has multiple panels. A panel in this sense is a group of related transmit antennas, as described in detail in PCT/EP2022/076975 (applicant's reference: P105366WO01). More precisely, since signals can arrive at a UE and emanate from it in all different directions, it is beneficial to have an antenna implementation at the UE with the ability to generate omni-directional-like coverage in addition to the high-gain narrow beams. One way to increase the omni-directional coverage at a UE is to install multiple panels with mutually different orientations, as illustrated in FIG. 4. Many commercially available UEs already have multiple panels at their disposal.

For UEs served by multi-TRP or D-MIMO mmWave deployments, it would seem a promising prospect to use UL beam management procedures, whereby it will be possible to determine a suitable beam pair link between any of the TRPs/APs and a UE in an overhead-efficient way. However, the current UL beam management procedures in 3GPP NR lack in preciseness, and they are therefore difficult to apply in a meaningful way. More precisely, it is currently not possible for the network to determine which of the UE beams (i.e., sounded by UL-RSs) can be used for simultaneous DL transmission or UL transmission, or both of these. Since the network does not know which UE beams that can be used for simultaneous DL reception and/or simultaneous UL transmission, the network has to refrain from scheduling the UE to transmit and/or receive from one or more TRPs/APs.

Further, if the network wishes to evaluate beam pair links to a UE from several different APs/TRPs, there may be insufficient data for a well-informed evaluation if the UE sounds only beams associated with one of the UE panels. Indeed, the different APs/TRPs might be located in many different directions with respect to the UE. Hence, the current NR UL beam management procedures are not well suited for multi-TRP and D-MIMO deployments, and updates to the UL beam management procedure are likely needed in coming releases of 3GPP NR and future 6G.

Related to this, the number of TX chains in a UE can differ from the number of RX chains, and the TX chains and the RX chains can have different circuit designs, including different TX/RX switching circuits. Hence, even if the network manages to determine the UE beams that can be used for simultaneous reception, it may not know which UE beams that can be used for simultaneous transmission.

Another related issue is that depending on the TX/RX panel switching network of a UE, which UE panels/beams that can be used for simultaneous transmission or simultaneous reception could be different for different UEs. To illustrate, FIG. 8 shows an example structure of a UE 120 with an ability to switch between different TX/RX panels 126. In this example, a first UE panel 126a cannot be used for simultaneous DL/UL transmission/reception with a second UE panel 126b as this would disconnect first UE panel 126a from the first TX/RX chain 122a, and in the same way the UE's third UE panel 126c cannot be used for simultaneous DL/UL transmission/reception with the fourth UE panel 126d. All other UE panel combinations support simultaneous DL/UL transmission/reception. In the example of FIG. 8, the same number of receiver chains and transmitter chains is used, and the same antenna switching network is used for both the transmitter side and the receiver side. However, this may not always be the case. For example, a UE may be able to receive on three or four UE panels simultaneously while only being able to transmit on one or two UE panels simultaneously.

It is finally noted that beam prediction based on machine learning (ML) or artificial intelligence (AI) is a promising and busy area of development, including an ongoing study item within 3GPP NR Release 18. To facilitate the AI/ML-based beam prediction, it is generally beneficial to accumulate as much information as possible—and as diverse information as possible—at the gNB. This includes information used for initially training the AI/ML model as well as information to be fed during operation to the trained model to obtain a decision. The current NR DL beam management procedures are of limited use for AI/ML based beam prediction, due to several uncertainties in the UE beam reporting. Indeed, the beam reporting is to a large extent dependent on UE implementation, e.g., which UE panel to use, which UE beam (e.g., wide, narrow) to use for the selected UE panel, how long the performance metric reported in the beam report shall be filtered in time etc., and thus out of the network's control. For similar reasons, the current NR UL beam management procedures are not very useful for AI/ML based beam prediction either, due to uncertainties about which panel the UE is using, which beams the UE is using for the selected UE panel etc. Accordingly, the need to improve the current NR UL beam management procedures is further underlined by the desire to provide more information at the gNB to facilitate AI/ML-based beam prediction. To enable SRS-based UL beam management procedures for multi-TRP or D-MIMO scenarios, the network needs to know which UE beams (i.e., SRS resources) can be used for simultaneous reception or simultaneous transmission, or both.

### SUMMARY

One objective of the present disclosure is to make available an improved way of determining beams to be used for simultaneous transmission and/or reception between a network node and a UE with multiple panels. A further objective is to leverage the transmission abilities of the multi-panel UE more completely, to achieve better-performing communication. In particular, this may include enabling communication using a globally optimal set of beam, with account taken of the UE's capability of simultaneous transmission and/or reception. A further objective is to allow a set of beams for simultaneous transmission to be determined independently of a further set of beams for simultaneous reception. A further objective is to allow the network to schedule a UE to transmit and/or receive from one or more TRPs/APs. A further objective is to propose pre-agreed signaling that adequately informs the network whether all panels can be used for simultaneous TX and/or RX, or only particular subgroups. A still further objective is to facilitate the use of ML-based beam prediction, including by providing more diverse and/or more complete data for training and decision-making.

At least some of these objectives are achieved by the invention as defined by the independent claims. The dependent claims relate to advantageous embodiments of the invention.

In a first aspect of the invention, there is provided a method in a wireless device for facilitating an uplink reference signal (UL RS) based beam management procedure. The method comprises: indicating to a network a capability of simultaneous transmission and/or reception from multiple panels, each panel representing a group of related antennas; receiving from the network an UL RS configuration indicating at least two UL RS resources to be transmitted from different panels; and transmitting on one or more of the UL RS resources using the different panels in accordance with the UL RS configuration.

In a second aspect, there is provided a wireless device (or UE) suitable for facilitating the determination of a beam to be used for communication with a network. The wireless device has processing circuitry configured to execute the method of the first aspect.

In a third aspect of the present disclosure, there is provided a method to be performed by a network node for determining a beam to be used for communication with a wireless device. The method comprises: receiving an indication of a capability of simultaneous transmission and/or reception from multiple panels of a wireless device, each panel representing a group of related antennas; transmitting to the wireless device an uplink reference signal (UL RS) configuration indicating at least two UL RS resources to be transmitted from different panels; and receiving a plurality of UL RSs from the wireless device in accordance with the UL RS configuration.

In a fourth aspect, there is provided a network node (e.g., base station, such as a gNB) suitable for determining a beam to be used for communication with a wireless device. The network node has processing circuitry configured to execute the method of the third aspect.

In a fifth aspect, there is provided a computer program containing instructions for causing a computer—or processing circuitry within the wireless device or network node in particular—to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

The first, second, third, fourth and fifth aspects are suitable for enabling the network to determine beams to be used for simultaneous transmission and/or reception between a network node and a UE with multiple panels. As a result, the network can choose to schedule the UE for simultaneous transmission and/or simultaneous reception on these beams. This leverages the transmission abilities of the multi-panel UE more completely. In particular the techniques disclosed herein could achieve better-performing communication at mmWave frequencies for a number of different deployments, such as D-MIMO deployments, multi-TRP deployments, mmWave base stations, networks with AI/ML-based beam prediction and deployments with ‘uplink-only’ nodes.

In some embodiments, the wireless device's indicated capability of simultaneous transmission and/or reception from multiple panels includes one or more of the following: a number of panels; a panel ID or virtual panel ID associated with each panel of the wireless device; a number of or identifiers of those panels that are capable of simultaneous transmission; a number of or identifiers of those panels that are capable of simultaneous reception; a number of or identifiers of one or more subgroups of panels such that the panels in each subgroup are capable of simultaneous transmission; a number of or identifiers of one or more subgroups of panels such that the panels in each subgroup are capable of simultaneous reception; a supported number of beams per panel; a number of transmit ports per panel; a number of receive ports per panel; a number of simultaneously transmittable beams per panel; a number of simultaneously receivable beams per panel.

In some embodiments, the UL RS configuration includes a UL RS resource group index for each UL RS resource set or each UL RS resource. This is a novel parameter which provides an efficient way of implicitly indicating which UL RS resource sets can be used for simultaneous transmission or simultaneous reception, or both.

In the present disclosure, a “beam” may be defined by an UL RS resource. More precisely, the UE may be required to sound a set of UL RS resources, wherein each UL RS resource is transmitted on a separate beam. The network may then schedule the UE on one of said beams by referring to one of the sounded UL RS resources, e.g., in terms of UL RS indices, which are in a one-to-one relationship with the corresponding beams.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 shows a wireless device in the coverage area of one single-TRP base station and one multi-TRP base station;

FIG. 2 illustrates three example beam management procedures;

FIG. 3 illustrates uplink beam management;

FIG. 4 is a perspective view of a wireless device (UE) with four panels;

FIG. 5 is a schematic drawing of a wireless device with three panels oriented in orthogonal directions to improve coverage, wherein the wireless device has one baseband chain at its disposal that can be connected to one of the panels at a time;

FIG. 6 depicts an example use case of the present disclosure, namely, a communication setup including a wireless device with three panels which operates in a multi-TRP/D-MIMO mmWave deployment;

FIG. 7 is a sequence diagram illustrating a method of determining a beam to be used for communication between a network node and a wireless device; and

FIG. 8 shows a switching network for a UE with four panels, where up to two panels can be used for simultaneous transmission.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

In general terms, the present disclosure proposes a signaling framework and capability reporting that supports a panel switching scheme in 5G/6G such that the network can configure a UE to transmit SRSs from all candidate UE panels using beams that cover the whole angular interval of the UE panel.

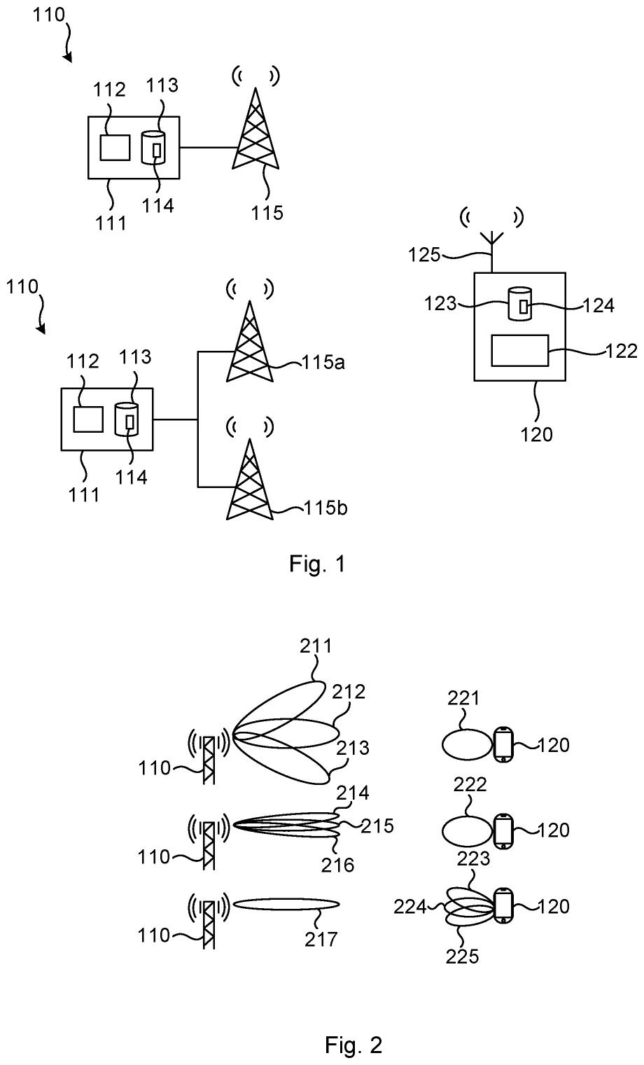

FIG. 1 relates to a first deployment where a wireless device 120 is located in the coverage area of one base station 110 with a single TRP 115 (upper portion of FIG. 1), and one base station 110 with two TRPs 115a, 115b (lower portion of FIG. 1). The base stations 110 are configured as network nodes in a radio access network within a cellular telecommunication system, such as a 3GPP NR system.

The figure schematically illustrates, in terms of a number of functional units, the components of the wireless device 120 according to an embodiment. Processing circuitry 122 is provided using any combination of one or more of a suitable central processing unit (CPU), multiprocessor, microcontroller, digital signal processor (DSP), etc., capable of executing software instructions stored in a computer program product 124, e.g. in the form of a storage medium 123. The processing circuitry 122 may further be provided as at least one application specific integrated circuit (ASIC), or field programmable gate array (FPGA). Particularly, the processing circuitry 122 is configured to cause the wireless device 120 to perform a set of operations, or steps, as disclosed below with reference to FIG. 7. For example, the storage medium 123 may store the set of operations, and the processing circuitry 122 may be configured to retrieve the set of operations from the storage medium 123 to cause the wireless device 120 to perform the set of operations. The set of operations may be provided as a set of executable instructions. Thus the processing circuitry 122 is arranged to execute the method for facilitating the determination of a beam to be used when the wireless device 120 communicates with the network node 110, to be described with reference to FIG. 7. The storage medium 123 may also comprise persistent storage, which, for example, can be any single one or combination of magnetic memory, optical memory, solid state memory or even remotely mounted memory.

The wireless device 120 may further comprise a communications interface 125 for communications with the network nodes 110. As such, the communications interface 125 may comprise one or more transmitters and receivers, comprising analogue and digital components. The processing circuitry 122 controls the general operation of the wireless device 120, e.g. by sending data and control signals to the communications interface 125 and the storage medium 123, by receiving data and reports from the communications interface 125, and by retrieving data and instructions from the storage medium 123. Other components, as well as the related functionality, of the wireless device 120 are omitted in order not to obscure the concepts presented herein.

FIG. 1 further illustrates, in terms of a number of functional units, the components of the network nodes 110 according to an embodiment. Each network node 110 comprises a frontend unit 111 and a TRP 115. The frontend unit 111 may be co-located with the TRP 115 or located remotely from this. In the frontend unit 111, processing circuitry 112 is provided using any combination of one or more of a suitable CPU, multiprocessor, microcontroller, DSP, etc., capable of executing software instructions stored in a computer program product 114, e.g. in the form of a storage medium 113. The processing circuitry 112 may further be provided as at least one ASIC or FPGA. Particularly, the processing circuitry 112 is configured to cause each network node 110 to perform a set of operations, or steps, as disclosed below with reference to FIG. 7. For example, the storage medium 113 may store the set of operations, and the processing circuitry 112 may be configured to retrieve the set of operations from the storage medium 113 to cause the wireless device 110 to perform the set of operations. The set of operations may be provided as a set of executable instructions. Thus the processing circuitry 112 is arranged to execute the method for determining a beam to be used when the network node 110 communicates with the wireless device 120, to be described with reference to FIG. 7. The storage medium 113 may also comprise persistent storage, as exemplified above.

The network node 110 may further comprise a communications interface including the TRP 115 for communications with the wireless device 120. As such, the communications interface may comprise one or more transmitters and receivers, comprising analogue and digital components. The processing circuitry 112 controls the general operation of the network node 110, e.g. by sending data and control signals to the communications interface (with the TRP 115) and the storage medium 113, by receiving data and reports from the communications interface, and by retrieving data and instructions from the storage medium 113. Other components, as well as the related functionality, of the network nodes 110 are omitted in order not to obscure the concepts presented herein.

### SRS

Before describing the inventors' contributions, some background concepts will be reviewed. In 3GPP NR, sounding reference signal (SRS) is used for providing a channel state indication (CSI) to the gNB in the UL. The usage of SRS includes, e.g., deriving the appropriate transmission/reception beams and/or performing link adaptation (i.e., setting the transmission rank and the MCS). SRS may further be used for selecting DL (e.g., for PDSCH transmissions) and UL (e.g., for PUSCH transmissions) MIMO precoding.

In LTE and NR, the SRS is configured via the Radio Resource Control (RRC) protocol, where parts of the configuration can be updated (for reduced latency) through MAC-CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the PDCCH which instructs the UE to transmit the SRS once, at a predetermined time.

When configuring SRS transmissions, the gNB configures, through the SRS-Config IE, a set of SRS resources and a set of SRS resource sets, where each SRS resource set contains one or more SRS resources.

### SRS Configuration

Each SRS resource is configured with the SRS-Resource IE in RRC. See ASN code in 3GPP TS 38.331 version 16.1.0, clause 6.3.2.

This version of the RRC protocol allows an SRS resource to be configured with respect to one or more of the following:
The number of SRS ports (1, 2, or 4), configured by the RRC parameter nrofSRS-Ports.
The transmission comb (i.e., mapping to every 2nd or 4th subcarrier), configured by the RRC parameter transmissionComb, which includes:
   The comb offset, configured by the RRC parameter combOffset, is specified (i.e., which of the combs should be used).
   The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
The time-domain position within a given slot, configured with the RRC parameter resourceMapping, which includes:
   The time-domain start position, which is limited to be one of the last 6 symbols (in NR Rel-15) or in any of the 14 symbols in a slot (in NR Rel-16), configured by the RRC parameter startPosition.
   The number of symbols for the SRS resource (that can be set to 1, 2 or 4), configured by the RRC parameter nrofSymbols.
   The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver.
The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
The RRC parameter resource Type determines whether the SRS resource is transmitted as periodic, aperiodic (singe transmission triggered by DCI), or semi persistent (same as periodic except for the start and stop of the periodic transmission is controlled through MAC-CE signaling instead of RRC signaling).
The RRC parameter sequenceld specifies how the SRS sequence is initialized.
The RRC parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

In 3GPP NR Release 16, the additional (and optional) RRC parameter resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and the repetition factor is still limited to 4) can start in any of the 14 OFDM symbols in a slot configured by the RRC parameter startPosition-r16.

Further, an SRS resource set is configured with the SRS-ResourceSet IE in RRC. See ASN code in 3GPP TS 38.331 version 16.1.0, clause 6.3.2.

SRS resource(s) will be transmitted as part of an SRS resource set, where all SRS resources in the same SRS resource set must share the same resource type. An SRS resource set is configurable with respect to one or more of the following:
For aperiodic SRS, the slot offset is configured by the RRC parameter slotOffset and sets the delay from the PDCCH trigger reception to the start of the SRS transmission.
The resource usage, which is configured by the RRC parameter usage sets constraints and assumptions on the resource properties (see 3GPP TS 38.214 for further details). SRS resource sets can be configured with one of four different usages (‘antennaSwitching’, ‘codebook’, ‘nonCodebook’ and ‘beamManagement’), which is assigned to the parameter ‘usage’.
   An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.
   An SRS resource set that is configured with usage ‘codebook’ is used for codebook-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.
   An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) the UE should apply for PUSCH transmission. One UL layer will be transmitted per indicated SRS resource. Note that how the UE maps SRS ports to antenna ports is up to UE implementation and not known to the gNB.
   An SRS resource set that is configured with usage ‘beamManagement’ is used (mainly for frequency bands above 6 GHZ, i.e., for FR2) to evaluate different UE beams for analog beamforming arrays. The UE transmits one SRS resource per analog beam, and the gNB will perform an RSRP measurement per transmitted SRS resource and, in this way, determine a suitable UE beam that is reported to the UE.
The associated CSI-RS (this configuration is only applicable for NCB-based UL transmission) for each of the possible resource types.
   For an aperiodic SRS, the associated CSI-RS resource is set by the RRC parameter csi-RS.
   For semi-persistent/periodic SRS, the associated CSI-RS resource is set by the RRC parameter associatedCSI-RS.
The PC parameters, e.g., alpha and p0 (p-zero) are used for setting the SRS transmission power. SRS has its own UL PC scheme in NR (see 3GPP TS 38.213 for further details), which specifies how the UE should split the available output power between two or more SRS ports during one SRS transmit occasion (an SRS transmit occasion is a time window within a slot where SRS transmission is performed).

To summarize, the SRS-ResourceSet configuration can be used to determine, inter alia, the usage, power control, and slot offset for aperiodic SRS. The SRS resource configuration determines the time-and-frequency allocation, the periodicity and offset, the sequence, and the spatial-relation information.

### SRS Antenna Switching

It is desirable for the gNB to sound all UE antennas, wherein sounding an antenna means transmitting an SRS from that antenna, which, in turn, enables the gNB to estimate the channel between said UE antenna and the antennas at the gNB. Since however it is generally costly to equip the UE with many transmit ports, SRS antenna switching was introduced in 3GPP NR Release 15, for several different UE architectures for which the number of receive chains is larger than the number of transmit chains. If a UE supports antenna switching, it will report so by means of UE-capability signaling.

As specified in 3GPP TS 38.306, a Release-15 UE can report the following antenna-switching capabilities using the IE supportedSRS-TxPortSwitch:
t1r2,
t1r4,
t2r4,
t2r2,
t4r4,
t1r4-t2r4.

For example, if a UE reports t1r2 in the UE-capability signaling, it means that it has two receive antennas (i.e., two receive chains) but only is capable of transmitting from one of those antennas at a time (i.e., one transmission chain) with support for antenna switching. In this case, two single-port SRS resources can be configured to the UE such that it can sound both receive ports using a single transmit port with an antenna switch in between.

Additional UE capabilities were introduced in NR Rel-16, where the IE supportedSRS-TxPortSwitch-r1610 can have values:

$$t 1 r 1 - t 1 r 2 ,$$

$$t 1 r 1 - t 1 r 2 - t 1 r 4 ,$$

$$t 1 r 1 - t 1 r 2 - t 2 r 2 - t 2 r 4 ,$$

$$t 1 r 1 - t 2 r 2 ,$$

$$t 1 r 1 - t 2 r 2 - t 4 r 4 ,$$

$$t 1 r 1 - t 1 r 2 - t 2 r 2 - t 1 r 1 - t 2 r 4.$$

This IE can be used to indicate support for the UE to be configured with SRS resource set(s) with usage ‘antennaSwitching’ but where only a subset of all UE antennas is sounded. For example, the UE capability t1r1-t1r2 means that the gNB can configure one single-port SRS resource (same as no antenna-switching capability) or two single-port SRS resources (same as for the capability “t1r2” described above) with usage ‘antennaSwitching’ per SRS resource set. In this case, if the UE is configured with a single SRS resource (no antenna switching), it will only sound only one of its two antennas, which will save UE power consumption at the cost of reduced channel knowledge at the gNB (since the gNB can only estimate the channel between itself and the UE based on one of the two UE antennas).

For SRS resources with usage ‘antennaSwitching’ for a UE with fewer transmit chains than receive chains, a guard period has to be configured between SRS resources to account for Tx switching transient time. For subcarrier spacing below 120 kHz the guard period is 1 OFDM symbol, while for sub-carrier spacing of 120 kHz it is 2 OFDM symbols. This means that a UE is expected to be able to switch antenna within one or two OFDM symbols, depending on sub-carrier spacing.

### Multi-Beam Operation

### Beam Management Procedure

In high frequency range (FR2), multiple RF beams may be used to transmit and receive signals at a gNB and a UE. For each DL Tx beam from a gNB, there is typically an associated best UE Rx beam for receiving signals from the DL beam. The DL beam and the associated UE Rx beam form a beam pair. The beam pair can be identified through a so-called beam management process in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of DL-RS in the reported best DL beam to let the UE evaluate candidate UE Rx beams.

Although not explicitly stated in the NR specification, beam management has been divided into three procedures, schematically illustrated in FIG. 2:
P-1: Purpose is to find an approximate direction for the UE 120 using wide gNB Tx beams 211, 212, 213 from the gNB 110 covering the whole angular sector. The UE 120 can use a single Rx beam 221.
P-2: Purpose is to refine the gNB Tx beam by doing a new beam search around the coarse direction found in P-1, namely, by transmitting regular (narrow) Tx beams 214, 215, 216. The UE 120 can use a single Rx beam 222.
P-3: Used for UEs that have analog beamforming to let them find a suitable UE Rx beam. In P-3, the UE 120 receives on multiple beams 223, 224, 225 while the gNB 110 transmits on a constant beam 217, which is preferably a regular (narrow) beam.

P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.

P-2 is expected to use aperiodic/or semi-persistent CSI-RS transmitted in narrow beams 214, 215, 216 around the coarse direction found in P-1.

P-3 is expected to use aperiodic or semi-persistent CSI-RSs repeatedly transmitted in one narrow gNB beam 217. One alternative way is to let the UE determine a suitable UE Rx beam based on the periodic SSB transmission. Since each SSB consists of four OFDM symbols, a maximum of four UE Rx beams 223, 224, 225 can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving a signal on the other antenna port. For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in 3GPP NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to receive also this signal.

In NR, the spatial QCL relation for a DL or UL signal/channel can be indicated to the UE by using a “beam indication”. The “beam indication” is used to help the UE to find a suitable Rx beam for DL reception, and/or a suitable Tx beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Release 15/16) or a TCI state (in NR Release 17).

### UL Beam Management

Some UEs might have analog beamformers without beam correspondence or with poor beam correspondence (i.e. Tx/Rx correspondence), which implies that DL/UL reciprocity cannot always be used to determine the beams for these beamformers. For such UEs, the UE beam used for UL cannot be derived from beam management procedures based on DL reference signals as described above. To handle such UEs, UL beam management has been included in the NR standard specification since release 15. The main difference between normal beam management and UL beam management is that UL beam management utilizes uplink reference signals instead of DL reference signals. The UL reference signals that have been agreed to be used for UL beam management is sounding reference signals (SRS).

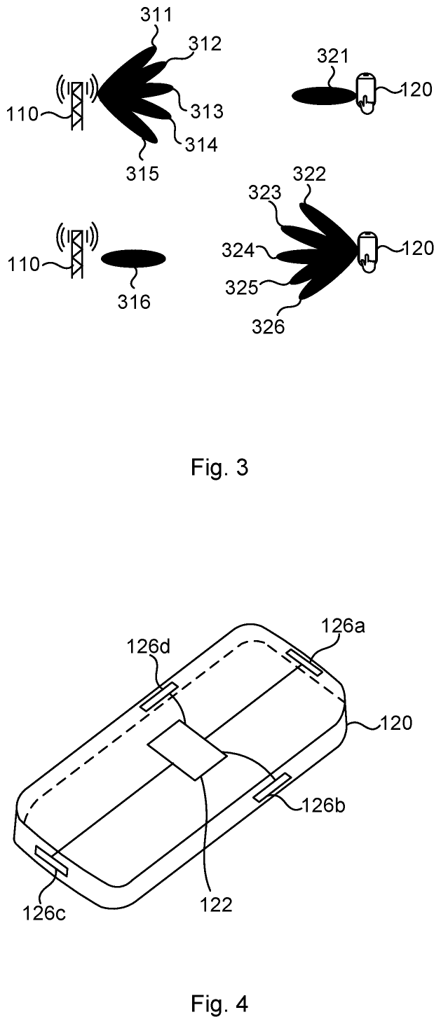

FIG. 3 schematically illustrates the two UL beam management procedures are supported in NR: U2 and U3. The U2 procedure (upper half) is performed by the UE 120 transmitting a burst of SRS resources in one UE Tx beam 321 and letting the gNB's TRP 110 evaluate different TRP Rx beams 311, 312, 313, 314, 315. The U3 procedure (lower half) lets the UE find a suitable UE Tx beam by transmitting different SRS resources in different UE Tx beams 322, 323, 324, 325, 326 while the TRP 110 maintains a constant beam 316.

UL beam management can also be useful even if UEs have beam correspondence. More precisely:
Some companies in 3GPP are arguing that a combined DL beam management procedure and UL beam management procedure requires less overhead and latency compared to only using DL beam management procedures.
So-called ‘Uplink-only’ node deployments are a hot topic in 3GPP to improve UL coverage in a cost-efficient way (especially at higher frequencies). An “UL only” network node is equipped with UL capability but with none or very limited downlink capability. In this case, since the “UL only” node is not capable of transmitting DL reference signals, the beam pair link between a UE and an “UL only” node has to be based on UL beam management procedures.
In D-MIMO, there will be many different access points (AP) or transmission points (TRPs) in a small area, and where each AP/TRP might be equipped with multiple different beams. In case DL-beam management is used to determine a suitable AP/TRP and corresponding AP/TRP beam to a UE, significant amount of reference signal overhead is needed, which has been identified as an issue for D-MIMO. Hence, it has internally been suggested AP/TRP selection and corresponding beam selection should preferably be based on UL SRS transmission from the UE (which then could be used to determine suitable AP/TRP and corresponding AP/TRP beams for that UE).

Hence, it is likely that UL beam management will play a more significant role for 5G Advanced and 6G applications.

### UE Panels

For UEs, the signals can arrive and emanate from all different directions, which makes it is beneficial to have an antenna implementation at the UE which has the possibility to generate omni-directional-like coverage in addition to the high gain narrow beams. One way to increase the omni-directional coverage at a UE is to install multiple panels, and point (orient) these panels into different directions, which typically is the case for commercial UEs. However, in order to reduce the cost and energy consumption, some of these UEs can only transmit from one UE panel at each point in time.

FIG. 4 illustrates one example of a realistic UE 120 with two baseband chains (one per polarization) 122 which are used to switch between four different dual-polarized panels 126. Each panel 126 is operable to transmit beams in directions typically corresponding to a half plane into the main transmit direction of the panel. More precisely, the antennas in one panel 126 may be oriented parallel to each other into a common direction. Oftentimes though not necessarily, the antennas in one panel 126 are physically close, e.g., the mutual distances of the antennas in one panel 126 are smaller than the distance to an antenna in any other panel. Further, the antennas in one panel 126 may be fed by an RF signal at a common input point, which can be connected and disconnected to the baseband chain 122 collectively.

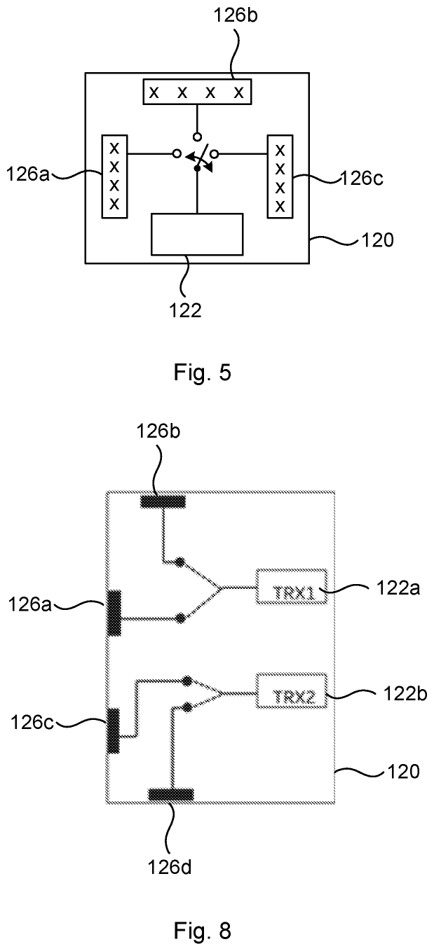

FIG. 5 shows a wireless device 120 with three panels 126 oriented in orthogonal directions to improve spherical coverage. The wireless device has one baseband chain 122 at its disposal that can be connected to one of the panels 126 at a time. This ability is illustrated by an analog switch in FIG. 5. With reference to a similar UE structure, it is described in the presentation
Qualcomm Technologies, Breaking the Wireless Barriers to Mobilize 5G NR mmWave, May 2019, downloaded from https://www.qualcomm.com/content/dam/qcomm-martech/dm-assets/documents/breaking_the_wireless_barriers_to_mobilize_5g_nr_mmwave.pdf how antenna switching can be used to switch between three UE panel modules M1, M2, M3.

A UE panel of a commercial UE can generate beams of different beam widths, for instance:

TABLE 1

| | | Equivalent | |
|---|---|---|---|
| | Half-power | isotropically | Number of |
| Beamforming | beam width | radiated power | pointing |
| gain | (HPBW) | (EIRP) | directions |
| 0 dB | 90 degrees | 13 dBm | 1 beam |
| 3 dB | 90 degrees | 19 dBm | 5 beams |
| 9 dB | 30 degrees | 25 dBm | 9 beams |

Typically, commercial UEs generate the wider beams by temporarily deactivating one or multiple power amplifiers (PAs) of the panel, which has a negative impact on the available output power. However, it is possible to mitigate the output power loss when generating wide beams by applying dual-polarized beamforming, e.g., using array-size-invariant (ASI) beamforming. It is useful for the UE to generate a wide beam of a panel during beam sweep procedures to first find a coarse direction to a serving AP/TRP, which would enable the UE to select and activate a suitable UE panel. In the example of Table 1, the UE can generate one wide beam, five semi-wide (or half-wide) beams, and nine narrow beams for each panel.

### Beam Selection Method

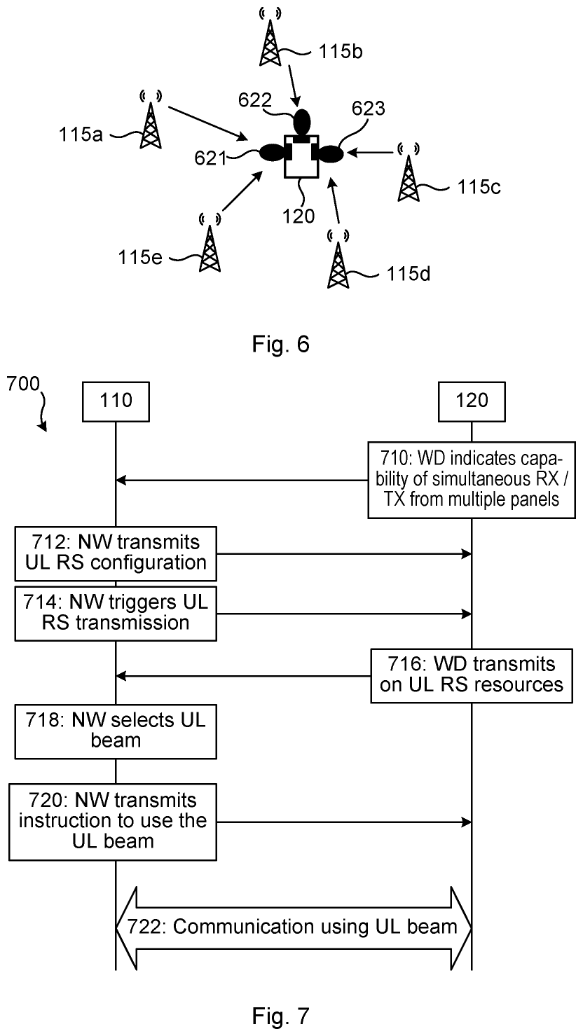

FIG. 6 illustrates a multi-TRP/D-MIMO mmWave deployment with five TRPs 115a, 115b, 115c, 115d, 115e. A mmWave wireless device (or UE) 120 with three panels is located in an intersection of coverage areas of the TRPs 115a, 115b, 115c, 115d, 115e. Each panel is operable to transmit beams 621, 622, 623 in directions typically corresponding to a half plane into the main transmit direction of each panel. Specifically, different UE panels are associated with different TRPs/APs 115.

To enable beam pair link selection between wireless device 120 and network, one option is to initially select a suitable combination of a TRP/AP 115 and a UE panel, and then perform a narrow beam sweep to determine a narrow beam for the determined UE panel and a narrow beam for the determined TRP/AP 115. It is assumed that the wireless device 120 can transmit UL-RSs in all different directions, e.g., by transmitting an UL-RS from all UE panels and where a wide beam 621, 622, 623 is used per UE panel. The other option is, instead of initially determining such a combination of a TRP/AP 115 and a UE panel, to directly transmit an SRS from each of the narrow beams over all UE panels; that would however introduce an unacceptable amount of SRS overhead signaling and latency. For example, assume that a wireless device 120 is equipped with 4 panels, and each panel has 9 narrow beams, then the wireless device 120 needs to sweep through 4×9=36 beams during each UL beam management procedure; because a simple wireless device 120 can usually only transmit from one beam from one panel at each time instance, this sweep would occupy no less than 36 OFDM symbols would be needed. In addition, in case the TRP/APs 115 need to perform TRP/AP beam sweeping procedures to determine a suitable TRP/AP beam for respective UE beam, each of the 36 SRS resources need to be repeated n times, where n is equal to the number of TRP/AP beams to be evaluated.

Reference is made to FIG. 7, which is a sequence diagram illustrating a method of determining one or more beams to be used for communication between a network node 110 and a wireless device 120. From the wireless device's 120 point of view, FIG. 7 provides a method for facilitating the determination of one or more beams to be used by the wireless device 120 for communication with the network node 110. From the network node's 110 perspective, FIG. 7 provides a method for determining one or more beams to be used by the wireless device 120 for communication with the wireless device 120; additionally the network node 110 may determine one or more beams for its own use in said communication. It is appreciated that the determined beams to be used by the wireless device 120 is transmitted from a specific ones of the panels, that is, the panels from which the UL RSs selected by the network node 110 were transmitted.

In an optional first step 710, the wireless device 120 indicates a capability of simultaneous transmission and/or reception from multiple panels 126, each panel representing a group of related antennas. The capability may be indicated by a further development of the capability signaling specified in 3GPP NR. More precisely, the capability that the wireless device signals may be referred to as a “Indication of simultaneous reception and/or transmission of UE beams/panels for UL beam management procedures”.

In some embodiments, the “Indication of simultaneous reception and/or transmission of UE beams/panels for UL beam management procedures” includes one or more of the following:
1. a number of panels;
2. a panel ID or virtual panel ID associated with each panel of the wireless device;
3. a number of or identifiers of those panels that are capable of simultaneous transmission;
4. a number of or identifiers of those panels capable of simultaneous reception;
5. a number of one or more subgroups of panels or identifiers of one or more subgroups of panels such that the panels in each subgroup are capable of simultaneous transmission;
6. a number of one or more subgroups of panels or identifiers of one or more subgroups of panels such that the panels in each subgroup are capable of simultaneous reception;
7. a supported number of beams per panel;
8. a number of transmit ports per panel; a number of receive ports per panel;
9. a number of simultaneously transmittable beams per panel;
10. a number of simultaneously receivable beams per panel.

With reference to item 2, it is noted that the “Indication” may in particular assign panel IDs or virtual panel IDs to all panels of the wireless device, so that additional information can be associated unambiguously with specific panels. It is understood that a virtual (or logical) panel ID is related to a physical panel ID according to a lookup table, e.g., a lookup table preconfigured by the UE implementer that is not transparent to the network 110.

The wireless device 120 can use item 3 to report its number of UE panels that can be used for simultaneous transmission and/or reception by indicating support for a number of UL RS (e.g., SRS) resource sets. Furthermore, the number of supported UL RS resources within a set correspond to a number of beams over a number of panels for which simultaneous transmission and/or reception is not possible. For example, the UE depicted in FIG. 8 may report that it supports two UL RS resource sets. Here, the number of UL RS resources that are supported for the first set corresponds to the number of beams over the upper panels 126a, 126b, and where the number of UL RS resources that are supported for the second set corresponds to the number of beams over the lower panels 126c, 126d.

As an alternative to item 3, the wireless device 120 can report its number of UE panels by indicating support for a number of UL RS resource sets. Within this alternative, it may have to be indicated separately—either implicitly or explicitly—which ones of these UE panels that can be used for simultaneous transmission and/or reception.

By means of item 5 or 6, the wireless device 120 can notify the network 110 that is not capable of simultaneous transmission/reception on all subgroups of panels but can do so on a number of the subgroups (which are possibly overlapping).

In a second step 712 of the method 700, the network 110 transmits—and the wireless device 120 receives
an UL RS configuration which indicating at least two UL RS resources to be transmitted from different panels. The at least two UL RS resources can be simultaneously transmitted or separated in time; however, because an important benefit of the present method 700 resides already in the fact that it allows the network 110 to schedule the wireless device 120 for communication with simultaneous transmission and/or reception (step 722), the simultaneous transmission of UL RSs is by no means essential.

In some embodiments, the UL RS configuration is grouped into UL RS resource sets, and each UL RS resource set is associated with a different panel of the wireless device. For example, the UL RS configuration may explicitly indicate a panel ID for each UL RS resource set. The UL RS configuration may for example include a sounding reference signal (SRS) resource, and the UL RS resource set may be identified by an SRS Resource Set Index in accordance with 3GPP NR specifications.

Under one option, the number of UL RS resource sets can be equal to the number of simultaneously transmitting and/or receiving panels according to the indicated capability of the wireless device.

Under another option, the UL RS configuration includes an implicit indication such that each UL RS resource set shall be associated with a panel of the wireless device 120. In the terminology of the present disclosure, an implicit indication may refer to a rule which has been pre-agreed between the network 110 and wireless devices 120 operating in the network 110, e.g., by means of a telecommunication standard. Because the pre-agreed rule yields equal outputs for equal inputs regardless of whether it is applied on the network side or the wireless device side, the amount of explicit signaling can usually be reduced. To mention one example, the pre-agreed rule may be that “all UL RS resources in one UL RS resource set shall be assigned to the same UE panel”. Then, if the configuration assigns a UL RS resource set with a certain UE panel, then consequently all further UL RS resources in that set will be assigned to the same UE panel. The transmission of each UL RS resource may be performed on a different beam of the UE panel.

In some embodiments, one the one hand, the wireless device's indicated capability of simultaneous transmission and/or reception from multiple panels includes a number of panels that are capable of simultaneous transmission and/or reception and, on the other hand, the UL RS configuration is grouped into fewer UL RS resource sets than the number of panels according to the indicated capability. Because the association of UL RS resource sets and UE panels of the wireless device 120 is therefore not unambiguous a priori, an association of a UL RS resource set and a panel of the wireless device may be indicated by a dynamic indication from the network to the wireless device. The association may be transmitted in step 714 together with the trigger. For example, the dynamic indication can be conveyed in a MAC control element (MAC-CE) or in Downlink Control Information (DCI).

In some embodiments, where the wireless device's 120 indicated capability of simultaneous transmission and/or reception from multiple panels includes a number of panels that are capable of simultaneous transmission and/or reception, the UL RS configuration is grouped into as many UL RS resource sets as said number of panels capable of simultaneous transmission and/or reception. Accordingly, the UE may independently assign the UL RS resource sets to the panels; the assignment need not be transparent to the network 110, as long as the assignment is maintained unchanged and used for the later communication. Specifically, the wireless device's 120 indicated capability of simultaneous transmission and/or reception from multiple panels includes a supported number of beams per panel, and the number of configured UL RS resources in an UL RS resource set is equal to said supported number of beams per panel. In each of these embodiments, the UL RS configuration may include an implicit indication such that transmission on two UL RS resources in a common UL RS resource set shall be non-simultaneous.

In still other embodiments, each UL RS resource set carries an UL RS resource group index, and the UL RS configuration includes an implicit indication such that transmission on two UL RS resource sets with equal UL RS resource group indices shall be non-simultaneous. The UL RS resource group index is a novel element in 3GPP NR specifications. Alternatively, each UL RS resource in an UL RS resource set carries an UL RS resource group index, and the UL RS configuration includes an implicit indication such that transmission on two UL RS resources with equal UL RS resource group indices shall be non-simultaneous.

To illustrate the usefulness of the UL RS resource group index, it is assumed in a first example that two UL RS resource sets are configured in step 712 for the wireless device 120 in FIG. 8, which has four UE panels, two of which can be used for simultaneous transmission or reception at a time. In this case, it makes sense to configure different values of the UL RS resource group index for different resources within each set. If each panel 126 can transmit 4 unique beams, say, then the two UL RS resource sets would have 8 resources each, such that half of the resources would be configured with resource group index=1 and the other half with resource group index=2. The resource group index could be configured implicitly, e.g. based on the order of enumeration, or explicitly. In configuring the UL RS resources, the network 110 may be guided by the information it has received in step 710, where the wireless device 120 indicates a capability of simultaneous transmission and/or reception from multiple panels 126, as described above.

In a second example, it is assumed that four UL RS resource sets are configured in step 712. Because the wireless device 120 has four panels 126, the UL RS resource group index is preferably configured at the level of one UL RS resource set. Pairs of the configured UL RS resource sets will share a common value of the UL RS resource group index, e.g., the first and third sets are configured with resource group index=1, and the second and fourth sets with resource group index=2. This ensures that the network 110 will not schedule simultaneous transmission or reception of multiple beams from one panel 126.

In a third step 714, the network 110 transmits information to the wireless device for triggering an UL RS transmission. The information may for instance be included in Downlink Control information (DCI). It is noted that the trigger is not necessarily absolute, but it may be subject to specified exceptions, such that the wireless device 120 shall not be required to transmit the UL RS when it is in a specific condition not known to the network 110.

Optionally, the transmitted information may indicate an association of a UL RS resource set and a panel of the wireless device. The indication may for example include an enumeration of the panel IDs to be used for the succession of UL RS resource sets. This allows the network 110 to make dynamic adjustments to the allocation of resource sets to panel even after it has transmitted the configuration in step 712. Alternatively, the transmitted information may indicate an association of a UL RS resource and a panel of the wireless device.

In other embodiments, the third step 714 may as well relate to an event-based trigger, by which the wireless device 120 determines it is to transmit on the UL RS resource by detecting a specific condition or event. In these embodiments, accordingly, the trigger is independent of actions taken by the network 110.

In a fourth step 716, the wireless device 120 transmits the UL RSs as triggered. This is to say, the wireless device 120 transmits on one or more of the UL RS resources using the different panels in accordance with the UL RS configuration.

In one embodiment, the wireless device 120 transmits all the UL RSs (e.g. SRSs) from all different panels at equal output power. In this way, it is easier for the network 110 to compare different beam pair links between the wireless device and the network and in this way determine the best beam pair link or links. Transmitting at equal output power may include overriding a configured UL power control and set the output powers equal for each UE panel. More precisely, the wireless device 120 could for example select an UL output power corresponding to the UE panel with highest output power and apply this for all the UE panels, or it could determine an average output power based on all the power control loops.

In a fifth step 718, the network node 110 selects one or more UL RSs out of the received UL RSs. The selection can be based on any suitable evaluation criterion. Further, a trained ML model may be used, as described in more detail below.

In some embodiments, step 718 includes selecting two, four, six etc. of the received UL RSs, which form one, two, three etc. beam pairs to be used for the subsequent communication between the wireless device 120 and network node 110.

It is understood that the network node 110 can receive the UL RSs at one or multiple APs/TRPs 115, allowing it to determine:
a preferred TRP/AP (for each wireless device or each UE panel),
one or more preferred beams for the preferred TRP/AP (for each wireless device or each UE panel),
a preferred UE panel, and/or
one or more preferred UE panel beams.

In a sixth step 720, the network node 110 communicates its selection to the wireless device 120 in the form of an instruction for the wireless device 120 to communicate with the network node 110 using beams corresponding to the selected one or more UL RSs. For example, the instruction may refer to one or more beams from a first panel and one or more beams from a second panel.

It is also possible for further beam management procedures to be executed during this step 720. For example, if a suitable combination of a UE panel and a TRP/AP 115 has been determined in step 720, further beam management procedures might be triggered to determine which beam to use for the selected TRP/AP 115 or to determine which beam to use for the selected UE panel, or both.

In a seventh step 722, the network node 110 and wireless device 120 communicate by uplink and/or downlink transmissions of data and signaling using said beams corresponding to the selected one or more UL RSs. Step 722 may include simultaneous uplink transmission from multiple UE panels and/or simultaneous downlink reception to multiple UE panels.

### ML-Based Beam Prediction

To facilitate the AI/ML-based beam prediction, it is generally beneficial to accumulate as much information as possible—and as diverse information as possible—at the gNB. This includes information used for initially training the AI/ML model as well as information to be fed during operation to the trained model to obtain a decision.

To respond to this need, the present disclosure further relates a method for training a ML model, which comprises: transmitting to a wireless device 120 an UL RS configuration indicating at least two UL RS resources to be transmitted from different panels 126, each panel representing a group of related transmit antennas; receiving at a network node 110 a plurality of UL RSs from the wireless device in accordance with the UL RS configuration; and providing training data on the basis of measurements on the received UL RSs. Optionally, the training data can further include a ground-truth selection of one of the received UL RSs which represents at least one beam suitable for communication between the network node 110 and the wireless device 120, wherein possibly the beam or beams have been successfully used for such communication.

Still further, the present disclosure relates a method for applying a ML model for beam selection, comprising: transmitting to a wireless device 120 an UL RS configuration indicating at least two UL RS resources to be transmitted from different panels 126, each panel representing a group of related transmit antennas; receiving at a network node 110 a plurality of UL RSs from the wireless device in accordance with the UL RS configuration; and providing decision data, on the basis of measurements on the received UL RSs, to a trained ML model; obtaining a beam selection decision from the ML model; and transmitting an instruction for the wireless device 120 to communicate with the network using beams corresponding to the selected one or more UL RSs.

FIG. 8 shows a UE 120 with a panel-switching network, which has been discussed above. In this example, the same number of receiver chains 122 and transmitter chains 122 is used, and the same antenna switching network is used for both the transmitter side and the receiver side. Other UEs may have a different structure or may differ in quantitative terms, or both.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method in a wireless device for facilitating an uplink reference signal, UL RS, based beam management procedure, the method comprising:
providing to a network an indication of a capability of simultaneous transmission and/or reception from multiple panels, each panel representing a group of related antennas, wherein the indication comprises:
a number of or identifiers of those panels that are capable of simultaneous reception; and/or
a number of or identifiers of one or more subgroups of panels such that the panels in each subgroup are capable of simultaneous reception;
receiving from the network an uplink (UL) reference signal (RS) configuration indicating at least two UL RS resources to be transmitted from different panels; and
transmitting on one or more of the UL RS resources using the different panels in accordance with the UL RS configuration.

2. The method of claim 1, further comprising:
obtaining a UL RS transmission trigger,
transmitting on said one or more of the UL RS resources further in accordance with the trigger.

3. The method of claim 2, wherein the trigger is included in information received from the network.

4. The method of claim 3, wherein the trigger indicates an association of a UL RS resource set and a panel of the wireless device or an association of a UL RS resource and a panel of the wireless device.

5. A method in a network node for facilitating an uplink reference signal (RS) based beam management procedure, the method comprising:
receiving an indication of a capability of simultaneous transmission and/or reception from multiple panels of a wireless device, each panel representing a group of related antennas, wherein the indication comprises:
a number of or identifiers of those panels that are capable of simultaneous reception; and/or
a number of or identifiers of one or more subgroups of panels such that the panels in each subgroup are capable of simultaneous reception;
transmitting to the wireless device an UL RS configuration indicating at least two UL RS resources to be transmitted from different panels; and
receiving a plurality of UL RSs from the wireless device in accordance with the UL RS configuration.

6. The method of claim 5, further comprising:
transmitting information to the wireless device for triggering an UL RS transmission.

7. The method of claim 6, wherein the information is included in Downlink Control information (DCI).

8. The method of claim 7, wherein the information indicates an association of a UL RS resource set and a panel of the wireless device or an association of a UL RS resource and a panel of the wireless device.

9. The method of claim 1, wherein the indication comprises:
a number of panels;
a panel ID or virtual panel ID associated with each panel of the wireless device;
a number of or identifiers of those panels that are capable of simultaneous transmission;
a number of or identifiers of one or more subgroups of panels such that the panels in each subgroup are capable of simultaneous transmission;
a supported number of beams per panel;
a number of transmit ports per panel;
a number of receive ports per panel;
a number of simultaneously transmittable beams per panel; and/or
a number of simultaneously receivable beams per panel.

10. The method of claim 1, wherein the UL RS configuration is grouped into UL RS resource sets, each UL RS resource set being associated with a different panel of the wireless device.

11. The method of claim 10, wherein the number of UL RS resource sets is equal to the number of simultaneously transmitting and/or receiving panels according to the indicated capability of the wireless device.

12. The method of claim 10, wherein the UL RS configuration includes an implicit indication such that each UL RS resource set shall be associated with a panel of the wireless device.

13. The method of claim 10, wherein:
each UL RS resource set carries an UL RS resource group index; and
the UL RS configuration includes an implicit indication such that transmission on two UL RS resource sets with equal UL RS resource group indices shall be non-simultaneous.

14. The method of claim 10, wherein the UL RS configuration explicitly indicates, for each UL RS resource set, a panel ID.

15. The method of claim 10, wherein:
each UL RS resource in an UL RS resource set carries an UL RS resource group index; and
the UL RS configuration includes an implicit indication such that transmission on two UL RS resources with equal UL RS resource group indices shall be non-simultaneous.

16. The method of claim 1, wherein:
the wireless device's indicated capability of simultaneous transmission and/or reception from multiple panels includes a number of panels that are capable of simultaneous transmission and/or reception; and
the UL RS configuration is grouped into fewer UL RS resource sets than the number of panels according to the indicated capability.

17. (canceled)

18. The method of claim 16, wherein
an association of a UL RS resource set and a panel of the wireless device is indicated by a dynamic indication from the network to the wireless device, and
the dynamic indication is conveyed in a MAC control element (MAC CE).

19. The method of claim 16, wherein
an association of a UL RS resource set and a panel of the wireless device is indicated by a dynamic indication from the network to the wireless device, and
the dynamic indication is conveyed in Downlink Control Information (DCI).

20. The method of claim 1, wherein the UL RS configuration includes a sounding reference signal (SRS) resource.

21. The method of claim 1, wherein:
the wireless device's indicated capability of simultaneous transmission and/or reception from multiple panels includes a number of panels that are capable of simultaneous transmission and/or reception; and
the UL RS configuration is grouped into as many UL RS resource sets as said number of panels capable of simultaneous transmission and/or reception.

22. The method of claim 21, wherein:
the wireless device's indicated capability of simultaneous transmission and/or reception from multiple panels includes a supported number of beams per panel; and
the number of configured UL RS resources in an UL RS resource set is equal to said supported number of beams per panel.

23. The method of claim 21, wherein the UL RS configuration includes an implicit indication such that transmission on two UL RS resources in a common UL RS resource set shall be non-simultaneous.

24. A wireless device for facilitating the determination of a beam to be used for communication with a network, the wireless device comprising processing circuitry configured to cause the wireless device to:
indicate to the network a capability of simultaneous transmission and/or reception from multiple panels, each panel representing a group of related antennas, wherein the capability comprises:
a number of or identifiers of those panels that are capable of simultaneous reception; and/or
a number of or identifiers of one or more subgroups of panels such that the panels in each subgroup are capable of simultaneous reception;
receive from the network an uplink (UL) reference signal (RS) configuration indicating at least two UL RS resources to be transmitted from different panels; and
transmit on one or more of the UL RS resources using the different panels in accordance with the UL RS configuration.

25. A network node for determining a beam to be used for communication with a wireless device, the network node comprising processing circuitry configured to:
receiving an indication of a capability of simultaneous transmission and/or reception from multiple panels of the wireless device, each panel representing a group of related antennas, wherein the capability comprises:
a number of or identifiers of those panels that are capable of simultaneous reception; and/or
a number of or identifiers of one or more subgroups of panels such that the panels in each subgroup are capable of simultaneous reception;
transmit to the wireless device an uplink (UL) reference signal (RS) configuration indicating at least two UL RS resources to be transmitted from different panels; and
receive a plurality of UL RSs from the wireless device in accordance with the UL RS configuration.

26. A non-transitory computer readable storage medium storing a computer program comprising instructions for configuring a wireless device to perform the method of claim 1.

27. A non-transitory computer readable storage medium storing a computer program comprising instructions for configuring a network node to perform the method of claim 5.

28. (canceled)
